(19) United States
(12) Patent Application Publication
(10) Pub. No.: US 2019/0199614 A1
(43) Pub. Date: Jun. 27, 2019

(54) Wi-Fi Home Network Enhancements

(71) Applicant: ARRIS Enterprises LLC, Suwanee, GA (US)

(72) Inventor: Krishna Prasad Panje, Bangalore (IN)

(21) Appl. No.: 15/855,076

(22) Filed: Dec. 27, 2017

(51) Int. Cl. H04L 12/26; H04L 12/24; H04W 24/08

(52) U.S. Cl. CPC H04L 43/103; H04L 63/20; H04W 24/08; H04L 41/142

(57) ABSTRACT

Methods and systems for exchanging sequential polls of data between a gateway and at least one access point. Each sequential poll includes data relating to statistics of the wireless network, and each sequential poll is performed only when at least one statistic of the wireless network has changed relative to a preceding poll.

### CROSS REFERENCE TO RELATED APPLICATIONS

None

### BACKGROUND

The subject matter of this application relates to wireless networks and more particularly to systems and methods for efficient polling of wireless home network data.

Wireless home networks typically include gateways as well as Extenders or Access Points (APs). Wireless access points are network devices to which client devices, such as cell phones, laptops, or other electronic devices connect to a wireless network. The access points, in turn, are each commonly connected to the gateway, which may be a wireless router for example, that allows wireless network data to be exchanged with other networks, e.g. the Internet, etc.

The Gateway and the APs usually connected to each other as a Local Area Network (LAN) or a Multimedia over Coax (MoCA). The gateway periodically polls the APs to collect information related to the client devices connected to each AP in the network, so as to coordinate the communication of competing data that each client device wishes to send over the wireless network. Using this polling data, the gateway issues configuration and steering commands to the APs as well as to clients.

The periodic polling of APs is typically accomplished using done over HTTP(S) protocols, and the polling duration (commonly referred to as a time-out) is typically about 1-2 seconds. As the number of APs increase to about four or more, polling of all APs in the network may leads to the inefficient use of bandwidth due to unnecessary overhead. For example, when the connection between the gateway and an AP occurs using HTTPS (over TLS), communication of polling data requires the re-establishment of client/server acknowledgements and even SSL key exchange, if an earlier session gets disconnected. Also, each time an AP is polled, it must gather Wi-Fi data such as client RSSI and channel utilization which involves accessing the driver responding via HTTPS. Because each AP must respond in this manner within the polling period, some APs may sometimes not have enough time to respond within the time-out. Yet, if the polling duration is extended too long, the GW may miss key client data, which may be needed for quick steering.

What is desired, therefore, are improved systems and methods for polling access points in a wireless network.

### BRIEF DESCRIPTION OF THE DRAWINGS

For a better understanding of the invention, and to show how the same may be carried into effect, reference will now be made, by way of example, to the accompanying drawings, in which:

FIG. 1 shows an exemplary wireless network implementing the systems and methods disclosed in the present application.

FIG. 2 shows an exemplary protocol used by a gateway according to the present disclosure.

FIG. 3 shows an exemplary protocol used by an access point according to the present disclosure.

### DETAILED DESCRIPTION

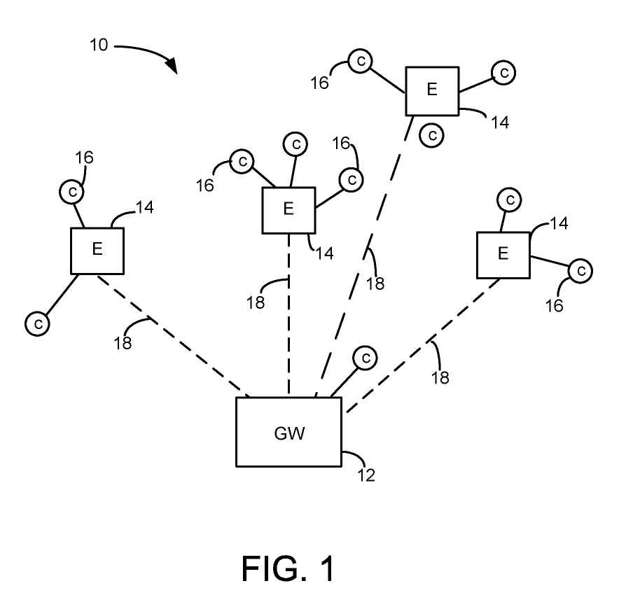

Referring to FIG. 1, a network environment 10 may preferably include a gateway 12 and a plurality of access points (or extenders) 14, each of which may in turn be connected to one or more client devices 16. The gateway 12 may, for example, be a router or any other device capable of transmitting and receiving signals to/from the respective access points 14 and relaying such signals to another network, e.g. the Internet. The client devices 16 may each be a device such as a cell phone, laptop, or other electronic device that connects to a wireless network.

As noted earlier, polling of all the APs in the network often leads to the inefficient use of bandwidth due to unnecessary overhead. The present inventor realized that a mechanism that optimized polling, to be performed at optimal times, could solve such inefficiency. Ordinarily, in order to maintain an up-to-date database of network topology, the gateway 12 sends periodic M-SEARCH requests to compatible APs in range, and APs 14 are configured to periodically send M-NOTIFY messages to the gateway, where each M-SEARCH and M-NOTIFY signal instantiates a new poll of network topology. The inventor realized that efficiency could be improved if the gateway 12 initially polls APs to discover network topology, performing an SSL handshake and a session establishment for HTTPS, but thereafter polling would only occur when changes were made to that initial topology.

After receiving the initial polling request from the gateway 12, each AP 14 would securely return its poll data as response. In some embodiments, the secure response may optionally include a session identification, for SSL optimization. Thereafter, the APs 14 send a coded M-NOTIFY or respond to M-SEARCH only with the specific POLL attribute that changed from a previous poll response. Once the gateway 12 receives information of which poll attribute had changed, the gateway 12 responds with an updated poll requesting network parameters related to the attribute that had changed. With this new polling technique, the gateway 12 can lengthen the periodic polling interval or poll only when key attributes change, thereby overcoming the drawbacks of existing polling methods.

Those of ordinary skill in the art will appreciate that some embodiments may have the APs send a coded M-NOTIFY, or respond to M-SEARCH, not only with information on what attribute had changed, but also all network parameters related to the changed attribute.

Furthermore, in some embodiments, the APs 14 may indicate the TLS session as intact with an identifier for a Poll response, or as part of an M-NOTIFY signal or response to an M-SEARCH request, and the gateway 12 can use that identifier to obviate the need for a TLS handshake for the subsequent Poll, which will significantly would reduce TLS overhead. In some embodiments predefined identifiers can be used to initiate a handshake or a change in the identifier can be used to trigger a new handshake. Those of ordinary skill in the art will appreciate that this feature may be implemented regardless of whether polling is performed based on a change in attributes as described above.

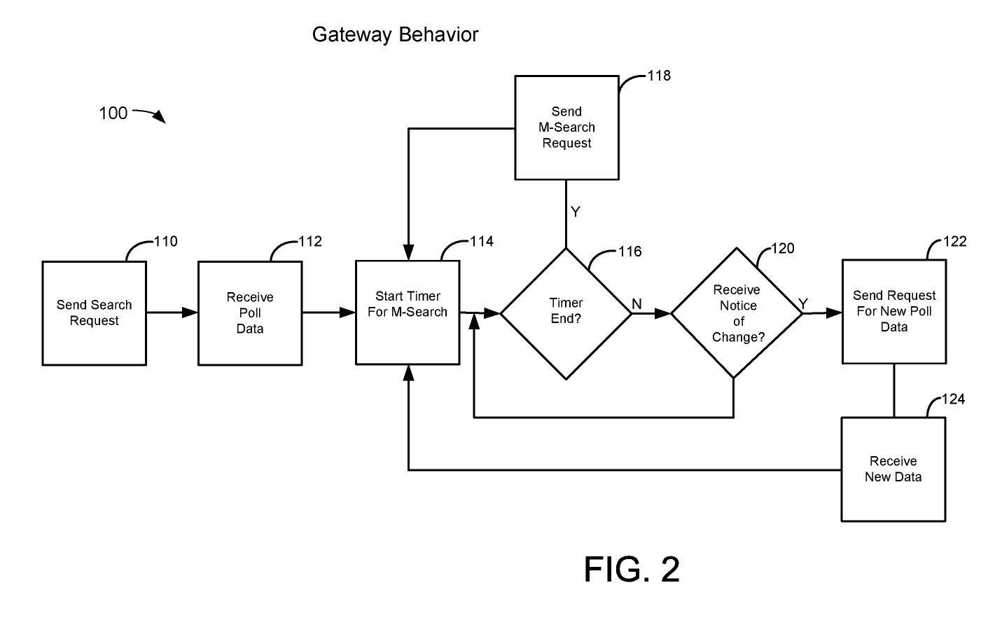

FIG. 2 shows an exemplary procedure 100 implemented by a gateway 12 in accordance with the present disclosure. At step 110 the gateway 12 preferably sends a search request to APs 14 in the network to obtain initial network topology, including client device statistics. This step preferably involves an SSL handshake between the gateway 12 and any network APs 14 along with a session establishment for HTTPS.

Some exemplary parameters from a typical poll from the gateway 12 may include:

<?xml version=“1.0” encoding=“US-ASCII”?><tr181i2>
<Device.WiFi.Radio.10100.Enable></Device.WiFi.Radio.10100.Enable>
<Device.WiFi.Radio.10100.Status></Device.WiFi.Radio.10100.Status>
<Device.WiFi.SSID.10101.SSID></Device.WiFi.SSID.10101.SSID>
<Device.WiFi.SSID.10101.BSSID></Device.WiFi.SSID.10101.BSSID>
<Device.WiFi.AccessPoint.10101.Enable></Device.WiFi.AccessPoint.10101.Enable>
<Device.WiFi.AccessPoint.10101.AssociatedDeviceNumberOfEntries></Device.WiFi.
AccessPoint.10101.AssociatedDeviceNumberOfEntries>
<Device.WiFi.AccessPoint.10101.AssociatedDevice.*.RSSI></Device.WiFi.
AccessPoint.10101.AssociatedDevice.*.RSSI>
<Device.WiFi.AccessPoint.10101.AssociatedDevice.*.MACAddress></Device.WiFi.
AccessPoint.10101.AssociatedDevice.*.MACAddress>
<Device.WiFi.Radio.10100.Stats._ChanUtilization></Device.WiFi.Radio.10100.Stats.
ChanUtilization>
<Device.WiFi.Radio.10100.Channel></Device.WiFi.Radio.10100.Channel≥<Device.Ethernet.
Interface.1.Enable></Device.Ethernet.Interface.1.Enable </tr181i2>

At step 112, the gateway 12 may receive responses to the initial poll request. Exemplary responses may include parameters such as

<?xml version=“1.0” encoding=“US-ASCII”?><tr181i2>.......
..........
<Device.WiFi.AccessPoint.10101.AssociatedDeviceNumberOfEntries>2
</Device.WiFi.AccessPoint.10101.AssociatedDeviceNumberOfEntries>
<Device.WiFi.AccessPoint.10101.AssociatedDevice.1.
.RSSI>20</Device.WiFi.AccessPoint.10101.AssociatedDevice.1.RSSI>
<Device.WiFi.AccessPoint.10101.AssociatedDevice.2.
RSSI>30</Device.WiFi.AccessPoint.10101.AssociatedDevice.2. RSSI>
....... ....
</tr181i2>

At step 114 the gateway 12 starts a timer for an M-SEARCH request. At decision step 116, if the timer has expired, then at step 118 the gateway 118 sends a next sequential M-SEARCH request and restarts the timer at step 114. Conversely, at decision step 116, during intervals when the timer has not yet ended, the gateway determines at decision step 120 whether it has received an M-NOTIFY message from an AP 14 indicating that a parameter of an attribute has changed relative to the data returned by the respective AP 14 in the preceding poll. If not, the procedure simply returns to the decision step 116. Thus, because the APs 14 will respond to an M-SEARCH request or send an M-NOTIFY request only when a parameter of an attribute has changed, the combination of decision steps 116 and 120 will simply ensure that the gateway 12 waits until such a response is received. Those of ordinary skill in the art will appreciate that, in some embodiments, the gateway 12 may omit sending M-SEARCH requests and simply rely on APs to respond with an appropriate M NOTIFY when an attribute has changed, or conversely, the gateway 12 may send periodic M-SEARCH requests and the APs 14 may respond to such requests without sending M-NOTIFY messages

If, at decision step 116 such a response is received from an AP 14, then the gateway 12 will at step 122 send a request for new poll data relevant to the changed parameter. For example, the gateway 12 may receive an M-NOTIFY message from an AP indicating that the number of client devices has changed, e.g. a message such as:

NOTIFY * HTTP/1.1\r\n
Host: 239.255.255.250:1900\r\n
NT: urn:arris-com:device:HNE:1.0\r\n
NTS:ssdp:alive\r\n
Location:http://192.168.1.200\r\n
USN: uuid:abcdefgh-1234-5678-abcd-001122334455::urn:arris-
com:device:HNE:1.0\r\n
Cache-Control: max-age = 1800\r\n
BOOTID.UPNP.ORG: 12\r\n
CONFIGID.UPNP.ORG: 1234\r\n
Changed_Name_Value: AssociatedDeviceNumberOfEntries = 3\r\n

Alternatively, the gateway 12 may receive a response to an M-NOTIFY request such as

HTTP/1.1 200 OK\r\n
CACHE-CONTROL: max-age = 1800\r\n
DATE: wkday, 00 mth 0000, 00:00:00 GMT\r\n
EXT:\r\n
LOCATION: http://a.b.c.d\r\n
SERVER: OS/version UPnP/1.1 product/version\r\n
ST: urn:arris-com:device:HNE:1.0\r\n
USN: uuid:abcdefgh-1234-5678-abcd-001122334455::urn:arris-
com:device:HNE:1.0\r\n
BOOTID.UPNP.ORG: x\r\n
CONFIGID.UPNP.ORG: y\r\n
Changed_Name_Value: AssociatedDeviceNumberOfEntries = 3\r\n

Thus, in each of these examples, the AP 14 notifies the gateway that the number of client devices 16 for that AP is now 3, where the prior poll results (shown above) indicated that the number of client devices 16 was 2.

In response, at step 122 the gateway 12 may send an updated poll request specific to that attribute for related parameters, e.g.

<Device.WiFi.AccessPoint.10101.AssociatedDeviceNumberOfEntries>
</Device.WiFi.AccessPoint.10101.AssociatedDeviceNumberOfEntries>
<Device.WiFi.AccessPoint.10101.AssociatedDevice.*.RSSI></Device.
WiFi.AccessPoint.10101.AssociatedDevice.*.RSSI>
<Device.WiFi.AccessPoint.10101.AssociatedDevice.*.MACAddress>
</Device.WiFi.AccessPoint.10101.AssociatedDevice.*.MACAddress>

and at step 124 the gateway 12 receives the new poll information from the AP 14.

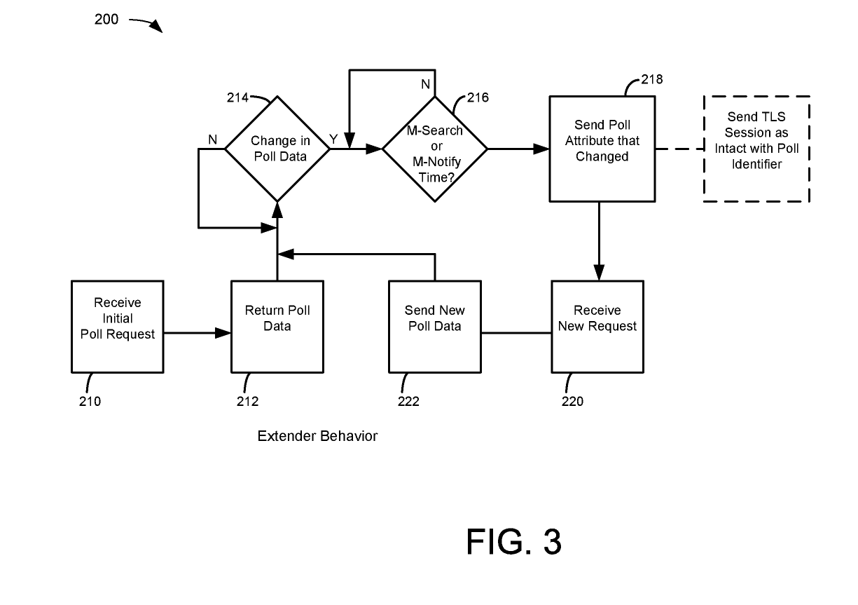

FIG. 3 shows an exemplary procedure 200 implemented by an AP 14 in accordance with the present disclosure. At step 210 the AP 14 receives an initial poll request and at step 212 returns the initial poll data. At decision step 214 the AP 14 determines whether a change has occurred relative to the initial poll data; if no such change has occurred the procedure simply returns to the decision step 214, i.e. no action takes place until such a change occurs. Conversely, if at decision step 214 the AP 14 determined that a change in a poll attribute has changed, then at step 216 the AP 14 determines whether it has received an M-SEARCH request or whether it is time to send an M-NOTIFY request. If the answer is no, then the process simply returns to decision step 216 until such a time occurs, and then at step 218 the AP 14 sends a message to the gateway 12, either as an M-NOTIFY message, or a response to an M-SEARCH request as applicable, informing the gateway 12 that the respective attribute has changed. At step 220 the AP 14 receives a request for updated parameters related to the changed attribute and step 222 the AP 14 sends the updated poll data. In some embodiments, the AP, while notifying the gateway 12 that a poll attribute has changed, may optionally include a step 219 informing the gateway that a TLS session is intact with a poll identifier, so that the gateway 12 will not need a handshake for the subsequent poll request 122 shown in FIG. 2. Such a message may comprise, for example:

NOTIFY * HTTP/1.1\r\n
Host: 239.255.255.250:1900\r\n
NT: urn:arris-com:device:HNE:1.0\r\n
NTS:ssdp:alive\r\n
Location:http://192.168.1.200\r\n
USN: uuid:abcdefgh-1234-5678-abcd-001122334455::urn:arris-
com:device:HNE:1.0\r\n
Cache-Control: max-age = 1800\r\n
BOOTID.UPNP.ORG: 12\r\n
CONFIGID.UPNP.ORG: 1234\r\n
SESSION_ID: 1257\r\n.

Those of ordinary skill in the art will appreciate that such a message indicating that a session is intact may be utilized, even in embodiments where polling is performed independently of whether a prior poll attribute has changed.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A device for communicating data to and from a client in a wireless network, the device capable of initiating sequential polls of data, each sequential poll comprising statistics relating to the wireless network, the device adapted to initiate a next sequential poll only when a statistic related to the wireless network has changed relative to a preceding poll.

2. The device of claim 1 comprising a gateway.

3. The device of claim 2 where the gateway initiates a request for the next sequential poll only after receiving a notice from an access point that a statistic related to the wireless network has changed relative to the preceding poll.

4. The device of claim 1 comprising an access point.

5. The device of claim 4 where the access point initiates a request for the next sequential poll by sending a notice to a gateway that a statistic related to the wireless network has changed relative to the preceding poll.

6. The device of claim 4 where the notice includes the statistics that have changed relative to the preceding poll.

7. The device of claim 1 where the next sequential poll only includes the statistics that have changed relative to the preceding poll.

8. A method comprising:
requesting initial poll data from at least one access point in a wireless network, the initial poll data including a plurality of attributes, each having at least one associated parameter;
determining whether an attribute of the initial poll data has changed relative to the initial poll data; and
requesting second poll data from the at least one access point, the requested second poll limited to parameters associated with the attribute that has changed.

9. The method of claim 8 performed by a gateway.

10. The method of claim 9 where the step of determining whether an attribute of the initial poll data has changed comprises receiving a response to an M-SEARCH request.

11. The method of claim 9 where the step of determining whether an attribute of the initial poll data has changed comprises receiving an M-NOTIFY request.

12. The method of claim 9 including the step of receiving a message that a TLS session is intact, and where the step of requesting second poll data is free from including a handshake.

13. A method comprising:
sending initial poll data to a gateway in a wireless network, the initial poll data including a plurality of attributes, each having at least one associated parameter;
determining whether an attribute of the initial poll data has changed relative to the initial poll data; and
sending second poll data to the gateway, the second poll limited to parameters associated with the attribute that has changed.

14. The method of claim 13 performed by an access point.

15. The method of claim 14 where the access point sends to the gateway a response to an M-SEARCH request indicating the attribute that has changed.

16. The method of claim 14 where the access point sends to the gateway an M-NOTIFY message indicating the attribute that has changed.

17. The method of claim 13 including the step of sending a message that a TLS session is intact, and where the step of sending second poll data is free from including a handshake.

18. A method comprising:
exchanging first poll data between a gateway and an access point;
exchanging at least one of an M-NOTIFY message and a response to an M-SEARCH request, where the at least one of an M-NOTIFY message and a response to an M-SEARCH request includes a message that a TLS session is intact; and
exchanging second poll data in a manner free from a handshake based on the message that the TLS session is intact.

19. The method of claim 18 where the at least one of the M-NOTIFY message and a response to an M-SEARCH request indicates that an attribute has changed, and the second poll data is exchanged in response to the indication that an attribute has changed.

20. The method of claim 19 where the at least one of the M-NOTIFY message and a response to an M-SEARCH request indicates which attribute has changed.
